(19) United States
(12) Patent Application Publication
(10) Pub. No.: US 2005/0260423 A1
(43) Pub. Date: Nov. 24, 2005

(54) Modified microsurfaces and methods of their manufacture

(76) Inventor: Mohan Natesan, Lorton, VA (US)

Correspondence Address: Sonia K Guterman, Esq.;Lawson & Weitzen, LLP, 88 Black Falcon Avenue, Suite 345, Boston, MA, 02210-2414, US

(21) Appl. No.: 10/847,755

(22) Filed: May 18, 2004

(51) Int. Cl. B32B 9/04; B05D 1/36; B05D 3/00

(52) U.S. Cl. 428/447; 428/429; 428/446; 428/448; 427/2.11; 427/402

(57) ABSTRACT

Surfaces and methods for producing surfaces for immobilizing biomolecules on a first side and modifying a second side to block non-specific interactions are provided.

### FIELD OF INVENTION

The present invention relates to surface chemistries for immobilizing biomolecules on one surface and preventing non-specific interactions on another surface of a microsurface such as a bimetallic cantilever.

### BACKGROUND OF THE INVENTION

Biosensors are powerful tools for measuring biomolecules, e.g., proteins, nucleic acids and lipids, and for measuring the interactions of biomolecules with other molecules. Generally, biosensors have a detector that senses a biological molecule or a signal mediated by the molecule, a transducer that converts the signal into an electronic signal, and a read-out system that amplifies and records the transduced signal. One class of biosensors uses microfabricated cantilevers as transducers that are capable of mediating a variety of signals, e.g., temperature, mass, stress and electromagnetic field, into a change in resonant frequency or deflection. See, e.g., Thundat et al., Microscale Thermophys. Eng. 1:185-199 (1997), Raiteri et al., Sens. Actuators B. 79:115-126 (2001), and Datskos et al., Micro and Nanocantilever Sensors. Encyclopedia of Nanoscience and Nanotechnology. Ed. H. S. Nalwa X:1-10 (2004).

Cantilever based biosensors detect a change in surface stress, which occurs when a ligand binds to a capture biomolecule immobilized on only one or predominantly on one side of the cantilever. In other words, cantilever deflection occurs from the differential stress of molecular adsorption occurring on only one side of a cantilever that has two surfaces that are chemically different.

The differential surface stress is the difference between the surface stress on top and bottom surfaces of a cantilever beam, in units of N/m. The relationship between cantilever bending and differential surface stress can be expressed as

$$z = \frac{3 {L}^{2} ( 1 - v )}{{Et}^{2}} σ$$

where z is deflection, E is Young's modulus (E_{Si}=1.7×10¹¹ N/M² for silicon), ν the Poisson's ratio (ν_{Si}=0.25), L the length, and t the thickness of the cantilever. Any variation in differential surface stress results in cantilever bending, which can be measured by several techniques including optical beam deflection, interferometry, piezoresistance, piezoelectric or capacitance methods.

A concern in cantilever-based biosensing is non-specific adsorption of macromolecules such as proteins. Depending on the location of cantilever contact, non-specific adsorption to the cantilever may result in poor sensitivity, or in false positive signals. In order to increase cantilever deflection, biomolecules should be associated with only one surface of the cantilever. Blocking a non-functionalized surface to prevent non-specific interactions increases cantilever deflection by increasing the bio-specific binding to one side relative to the non-specific binding to the other side.

Common techniques to reduce non-specific adsorption are based on exposing the surfaces to other adhesive proteins, e.g., Bovine Serum Albumin (BSA), casein and gelatin. This technique is useful for assays that use ligands having detectible labels such as enzyme linked immunosorbent assays (ELISA), however is unsuitable for label free sensors such as cantilevers. The cantilevers can be “passively blocked” by incubating the surfaces with solutions containing these proteins. However, the efficiency of this method is questionable and the mechanism of action is not well defined. The physically adsorbed adhesive proteins may contribute to the problems, for example, by desorbing from the surface during the course of the assay, for example, by displacement by molecules with higher affinity for the surface. Also, physically adsorbed adhesive proteins can interact with other macromolecules in the test solution and thereby interfere with the sensitivity. Physically adsorbed adhesive proteins can also bind to immobilized capture biomolecules and block ligand binding. Despite these problems, passive blocking remains in use. See, e.g., Grogan et al., Biosens. Bioelecton. 17:201-207 (2001); Wu et al., Nature Biotech. 19:856-860 (2001); Arntz et al., Nanotech. 14:86-90 (2003).

Non-specific interactions may be addressed in a step-wise manner by ‘active blocking,’ which is immobilizing molecules that are protein resistant on a cantilever surface. For example, a gold surface may be functionalized using a thiol chemistry in a first step, followed by silanization of the silicon surface in a second step. The amine-terminated silane may be blocked with molecules, e.g., N-Hydroxysulfosuccinimide (NHS)-linked molecules that provide resistance to non-specific interactions, such as oligo- or poly-ethylene glycol. However, this approach requires stringent conditions. Before the second step, the non-functionalized surface must be cleaned because the gold-thiol chemistry and the silanization method require very clean surfaces. Surface contaminants or non-clean surfaces interfere with the procedure and cause large defects in a deposited monolayer. Several cleaning methods, such as ozone/UV, plasma, ultrasonics, piranha, or acid/base procedures can be used for cleaning surfaces. However, these methods completely remove the previously deposited organic films.

Other approaches to depositing thin organic layers selectively on one side also are technically challenging. For example, silanes can be vapor deposited on one side of a silicon cantilever, while physically blocking the other side. After depositing the silane layer, gold film may be added by evaporation or sputtering. However, the increased temperature during the gold coating procedure may partially or completely destroy the silane layer.

Thus passive blocking of surfaces with adhesive proteins is inadequate for the demands of cantilever-based biosensors. Active blocking of the non-functionalized surface improves the performance of cantilever-based biosensors relative to passive blocking. However, the dual surface nature of the cantilevers prevents active blocking of non-functionalized surface by conventional methods.

There is a need in the art for better methods and systems of immobilizing biomolecules and preventing non-specific binding on cantilevers.

### SUMMARY OF THE INVENTION

In one aspect, the invention relates to methods for modifying a substrate that has a first and second surface, by immobilizing capture biomolecules on the first surface and blocking the second surface with molecules resistant to non-specific interactions. The surface is generally a “microsurface”, i.e., of small dimension on the order of microns, and is a flat “lamella” shaped material, i.e., the first and second surfaces are the predominant surfaces.

The method includes contacting the first surface with at least one thiol compound and the second surface with at least one silane compound; blocking the second surface with an NHS ester of an oligo ethylene glycol (OEG) compound; and immobilizing a capture biomolecule with a cross-linking agent to a terminal active group on the first surface, thereby modifying the substrate. The first surface can be aluminum, copper, gold, chromium, nickel, platinum, titanium or silver. Similarly, the second surface can be aluminum oxide, iridium oxide, silicon, silicon oxide, silicon nitride, tantalum pentoxide, or a plastic polymer. In one embodiment, the first surface includes gold, and the second surface includes silicon.

In an embodiment of the method, contacting the first surface and the second surface is simultaneous. The simultaneous contacting can further include applying an organic solvent containing the thiol compound and the silane compound. Alternatively, contacting the first surface and the second surface can be sequential.

In one embodiment, the thiol on the first surface and the silane on the second surface are monolayers. In one embodiment, the thiol in on SH-(oligo ethylene glycol)ₙ—R, where n is an integer that is at least two, for example, is four, is ten, or is 70, and R is an active functional group. The active functional group can be COOH, NH₂ NHS, epoxy, vinyl, aldehyde, maleimide, or methacryl.

In another embodiment, the thiol compound is sulfhydryl octaethylene glycol propionic acid or sulfhydyl tetraethylene glycol acid. In another embodiment, the thiol compound can be a mixture, having at least one of sulfhydryl octaethylene glycol propionic acid, sulfhydyl tetraethylene glycol acid and sulfhydryl triethylene glycol. A molar ratio of sulfhydryl octaethylene glycol propionic acid to sulfhydryl triethylene glycol can be, for example, about 1:10, or about 1:5, or about 1:2, or about 1:1. Similarly, a molar ratio of sulfhydryl tetraethylene glycol acid to sulfhydryl triethylene glycol is about 1:10, or about 1:5, or about 1:2, or about 1:1.

In one embodiment, the thiol compound is biotin-octaethylene glycol disulfide. The method can further comprise adding an avidin compound after the contacting step. In one embodiment, after adding the avidin compound, the method further includes adding a biotin-conjugated capture biomolecule. In another embodiment, immobilizing a capture biomolecule is adding an avidin compound that further includes a capture biomolecule.

In one embodiment, the silane compound is 3-aminopropyltriethoxysilane or an organosilane of formula RₙSi(X)₄₋ₙ, wherein R is a non-hydrolyzable functionalized organic group, X is a hydrolyzable group and n is an integer from 1 to 3. For example, R can be an alkyl, an aryl, or an organofunctional group. Similarly, X can be an alkoxy. In one embodiment, the alkoxy is methoxy or ethoxy.

In another aspect, the invention relates to a method for modifying microsurfaces for immobilizing capture biomolecules on a first surface, and immobilizes molecules resistant to non-specific interactions on a second surface. The method involves applying a layer having at least one thiol compound to the first surface and a layer having at least one silanated hydroxy- or alkoxy-terminated oligoethylene glycol to the second surface; and blocking the layer on the second surface with an NHS ester of an oligo ethylene glycol (OEG) compound, thereby modifying the microsurfaces. The NHS ester of the OEG compound is, for example, an NHS ester of tetra ethylene glycol.

In still another aspect, the invention provides a method for modifying microcantilever surfaces to immobilize capture biomolecules on a gold surface and to place molecules resistant to non-specific interactions on a silicon surface. The method involves applying a layer having at least one thiol compound to the gold surface and a layer having at least one silane compound to the silicon surface; blocking the layer on the silicon surface with an NHS ester of an oligo ethylene glycol compound; and immobilizing a capture biomolecule with a cross-linking agent to a terminal active group formed by the layer on the gold surface, to modify the microcantilever surfaces. In one embodiment, applying the layer involves contacting the microcantilever surfaces with an organic solvent having at least one thiol compound and at least one silane compound. In general, at least one thiol means one or more thios, i.e., a mixture of two or more thiols can be used. Similarly, at least one silane means that a mixture of two or more silanes may be used.

In another aspect, the invention provides a method for modifying microsurfaces to immobilize molecules resistant to non-specific interactions on a first side and to immobilize capture biomolecules on a second side. The method includes applying at least one thiol compound to the first side and at least one silane compound to the second side, wherein the first side is gold and the second side is silicon; and immobilizing capture biomolecules on the silane-layer of the second side, thereby modifying the microsurfaces. In one embodiment, the thiol compound is sulfhydryl tri ethylene glycol or sulfhydryl octaethylene glycol methyl ether. Applying the one or more thiol compounds and the one or more silane compounds can be simultaneous.

In one embodiment, the silane further comprises a terminal group that can be an amine, a chloro or a thiol, so that prior to immobilizing the capture biomolecules, the method can further include converting the terminal group such as the amino to a carboxyl functional group. Converting can be reacting with methyl-N-succimimidyl adipate, thereby providing the carboxyl functional group. Capture biomolecules can be reacted with the carboxyl functional group. Alternatively, reacting can be cross-linking with carbodiimide. Alternatively, prior to immobilizing the capture biomolecules, the method can further comprise cross-linking by reacting with glutaraldehyde.

In one embodiment, the method further comprises blocking the thiol layer after applying the at least one thiol compound. The blocking can comprise reacting with a small chain length agent, which can be triethylene glycol thiol.

In another aspect, the invention provides a method for modifying microcantilevers for immobilizing molecules resistant to non-specific interactions on a gold surface and immobilizing capture biomolecules on a silicon surface. The method comprises contacting the microcantilever surfaces with an organic solvent containing at least one thiol compound and at least one amine-terminated silane compound, wherein the thiol compound forms a layer on the gold surface and the amine-terminated silane compound forms a layer on the silicon surface; and immobilizing capture biomolecules on the silane layer by cross-linking, thereby modifying the microcantilevers.

In another aspect, the invention relates to microsurfaces or microcantilever produced by the any of the methods provided.

In still another aspect, the invention provides a modified microsurface, which is a silicon wafer with a first surface and a second surface for use in biosensors, the first surface having a thiol layer of at least one thiol compound, and the second surface having a silane layer of at least one silane compound. The first surface can include aluminum, copper, gold, chromium, titanium, nickel, platinum, and silver. Similarly, the second surface can include aluminum oxide, iridium oxide, silicon, silicon oxide, silicon nitride, tantalum pentoxide, and a plastic polymer. In one embodiment, the thiol layer and the silane layer are monolayers.

The thiol layer can further include an immobilized capture biomolecule. Similarly, the silane layer can further include a blocking agent. In another embodiment, the thiol layer further includes immobilized capture biomolecules and the silane layer further includes molecules resistant to non-specific interactions.

In one embodiment, the thiol layer includes SH-(oligo ethylene glycol)ₙ-R, wherein n is an integer that is at least 2 and R is an active functional group. The active functional group can be COOH, NH₂ or NHS.

In another embodiment, the thiol layer includes biotin-octaethylene glycol disulfide. The biotin can be conjugated to avidin.

In one embodiment, the thiol layer includes sulfhydryl octaethylene glycol propionic acid. In another embodiment, the thiol layer includes sulfhydryl octaethylene glycol propionic acid and sulfhydryl triethylene glycol. The molar ratio of sulfhydryl octaethylene glycol propionic acid to sulfhydryl triethylene glycol can be about 1:10, or about 1:5, or about 1:2, or about 1:1.

In one embodiment, the blocking agent includes an NHS ester of an OEG compound. The NHS ester of the OEG compound can be an NHS ester of tetra ethylene glycol.

In another embodiment, the silane layer includes 3-aminopropyltriethoxysilane, or an organosilane of RₙSi(X)₄₋ₙ, and R is a functionalized organic group, X is a hydrolyzable group and n is an integer from 1 to 3. The hydrolyzable group can be an alkoxy. Further, the alkoxy can be a methoxy or an ethoxy.

In another embodiment, the silane layer further includes an immobilized capture biomolecule. Similarly, in one embodiment, the silane layer further includes an immobilized capture biomolecule and the thiol layer further includes an active blocking agent.

In another embodiment, the thiol layer further comprises an active blocking agent, which can be a small chain length agent. In one embodiment, the small chain length agent is triethylene glycol thiol.

In another embodiment, the thiol layer comprises sulfhydryl tri ethylene glycol or sulfhydryl octaethylene glycol methyl ether.

In another aspect, the invention provides a microcantilever for use in biosensors, which is a silicon wafer with a gold surface and a silicon surface, and the gold surface comprises a thiol monolayer further comprising an active blocking agent, and the silicon surface comprises a silane monolayer further comprising a capture biomolecule.

The above description sets forth features of the present invention in order that the detailed description thereof that follows may be understood, and in order that the present contributions to the art may be better appreciated. Other objects and features of the present invention will become apparent from the following detailed description considered in conjunction with the examples and the claims, which are exemplary and not further limiting.

### BRIEF DESCRIPTION OF THE DRAWINGS

FIG. 1 is a bar graph that shows non-coated gold surfaces and non-coated silicon nitride surfaces readily adsorb proteins in comparison to a gold surface coated with sulfhydryl triethylene glycol (SH-PEG₃-OH).

FIG. 2 is a schematic representation of a surface chemistry scheme for immobilizing biomolecules on the gold surface according to the present invention.

FIG. 3 is a schematic representation of a surface chemistry scheme for immobilizing biomolecules on the silicon surface according to the present invention.

FIG. 4 is a bar graph showing thiols in a mixture with silanes form SAM preferably on gold surface.

FIG. 5 is a bar graph showing a comparison of thiol SAMs formed by conventional methods and by an embodiment of the invention.

FIG. 6 is a bar graph showing active blocking of silicon surfaces to prevent non-specific adsorption of proteins.

FIG. 7 is a schematic diagram of a cantilever deflection-monitoring unit, which may be used to study the interaction of immobilized biomolecules with ligands.

FIG. 8 is a representation of modifying compounds used by the embodiments of the present invention

### DETAILED DESCRIPTION OF EMBODIMENTS

The details of one or more embodiments of the invention are set forth in the accompanying description below. Methods and materials similar or equivalent to those described herein can be used in the practice or testing of the present invention. Other features, objects, and advantages of the invention will be apparent from the description. In the specification, the singular forms also include the plural unless the context clearly dictates otherwise. Unless defined otherwise, all technical and scientific terms used herein have the same meaning as commonly understood by one of ordinary skill in the art to which this invention belongs.

Definitions

The following terms shall have the following meanings in the specification and claims unless otherwise required by the context.

The term “alkyl” includes saturated aliphatic groups, including straight-chain alkyl groups (e.g., methyl, ethyl, propyl, butyl, pentyl, hexyl, heptyl, octyl, nonyl, decyl), branched-chain alkyl groups (e.g., isopropyl, tert-butyl, isobutyl), cycloalkyl (e.g., alicyclic) groups (e.g., cyclopropyl, cyclopentyl, cyclohexyl, cycloheptyl, cyclooctyl), alkyl substituted cycloalkyl groups, and cycloalkyl substituted alkyl groups. “Alkyl” further includes alkyl groups that have oxygen, nitrogen, sulfur or phosphorous atoms replacing one or more hydrocarbon backbone carbon atoms. In certain embodiments, a straight chain or branched chain alkyl has six or fewer carbon atoms in its backbone (e.g., C₁-C₆ for straight chain, C₃-C₆ for branched chain), and more preferably four or fewer. Likewise, preferred cycloalkyls have from three to eight carbon atoms in their ring structure, and more preferably have five or six carbons in the ring structure. “C₁-C₆” includes alkyl groups containing one to six carbon atoms.

The term “alkyl” also includes “unsubstituted alkyls” and “substituted alkyls”, the latter of which refers to alkyl moieties having substituents replacing a hydrogen on one or more carbons of the hydrocarbon backbone. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety. Cycloalkyls can be further substituted, e.g., with the substituents described above. An “alkylaryl” or an “aralkyl” moiety is an alkyl substituted with an aryl (e.g., phenylmethyl (benzyl)). “Alkyl” also includes the side chains of natural and unnatural amino acids.

The term “capture biomolecules” means a molecule or molecules that preferably bind to another molecule or molecules in a specific manner. The biomolecule may be a protein, nucleic acid, lipid etc. Antigens, antibodies, biologically DNA, RNA or receptors may serve as capture biomolecules, however, any molecule of biological relevance, whether extracted from a natural source or prepared synthetically, may be used.

The term “aryl” includes groups with at least one aromatic group, including 5- and 6-membered “unconjugated”, or single-ring, aromatic groups that may include from zero to four heteroatoms, as well as “conjugated”, or multicyclic systems with at least one aromatic ring. Examples of aryl groups include benzene, phenyl, pyrrole, furan, thiophene, thiazole, isothiazole, imidazole, triazole, tetrazole, pyrazole, oxazole, isooxazole, pyridine, pyrazine, pyridazine, and pyrimidine, and the like. Furthermore, the term “aryl” includes multicyclic aryl groups, e.g., tricyclic, bicyclic, e.g., naphthalene, benzoxazole, benzodioxazole, benzothiazole, benzoimidazole, benzothiophene, methylenedioxyphenyl, quinoline, isoquinoline, napthridine, indole, benzofuran, purine, benzofuran, deazapurine, or indolizine. Those aryl groups having heteroatoms in the ring structure may also be referred to as “aryl heterocycles”, “heterocycles,” “heteroaryls” or “heteroaromatics”. The aromatic ring can be substituted at one or more ring positions with such substituents as described above, as for example, halogen, hydroxyl, alkoxy, alkylcarbonyloxy, arylcarbonyloxy, alkoxycarbonyloxy, aryloxycarbonyloxy, carboxylate, alkylcarbonyl, alkylaminocarbonyl, aralkylaminocarbonyl, alkenylaminocarbonyl, alkylcarbonyl, arylcarbonyl, aralkylcarbonyl, alkenylcarbonyl, alkoxycarbonyl, aminocarbonyl, alkylthiocarbonyl, phosphate, phosphonato, phosphinato, cyano, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety. Aryl groups can also be fused or bridged with alicyclic or heterocyclic rings, which are not aromatic so as to form a multicyclic system (e.g., tetralin, methylenedioxyphenyl).

The term “alkoxy” or “alkoxyl” includes substituted and unsubstituted alkyl, alkenyl, and alkynyl groups covalently linked to an oxygen atom. Examples of alkoxy groups (or alkoxyl radicals) include methoxy, ethoxy, isopropyloxy, propoxy, butoxy, and pentoxy groups. Examples of substituted alkoxy groups include halogenated alkoxy groups. The alkoxy groups can be substituted with groups such as alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moieties. Examples of halogen substituted alkoxy groups include, but are not limited to, fluoromethoxy, difluoromethoxy, trifluoromethoxy, chloromethoxy, dichloromethoxy, and trichloromethoxy.

The term “microsurface” means an object of micron (micrometer or μm) dimensions generally having two surfaces or sides that are of predominant geometry, i.e., a lamella or flat object of micron dimensions. In general, the length is about 10 μm, about 20 μm, about 50 μm, about 100 μm, about 200 μm, about 500 μm or about 1,000 μm; width is about 5 μm, about 10 μm, about 20 μm, about 50 pin, about 100 μm, about 200 μm, and height is about 0.1 μm, about 0.5 μm, about 1 μm, or about 5 μm. An exemplary microsurface is a microcantilever having a length of from about 1 μm to about 50 μm, about 20 μm to about 150 μm, about 50 μm to about 250 μm, about 100 μm to about 400 μm, about 200 μm to about 500 μm, about 250 μm to about 750 μm, or about 500 μm to 1,000 μm. The microcantilever has a width of about 1 μm to about 50 μm, about 5 μm to about 20 μm, about 10 μm to about 30 μm, about 20 μm to about 50 μm, about 25 μm to about 100 μm, about 50 μm to about 200 μm, or about 100 μm to 200 μm. The microcantilever has a height of about 0.1 μm to about 0.5 μm, about 0.2 μm to about 1.0 μm, about 0.5 μm to about 1.0 μm, about 0.1 μm to about 1.0 μm, about 0.6 μm to about 2.0 μm, or about 0.1 μm to about 2.0 μm. However the methods and microsurfaces herein are not limited to cantilevers and may have any shape or degree of flexibility or oscillatory property, and a flat lamella in which length and width predominate height is most appropriate.

The term “passive blocking” means a method by which a macromolecule in a solution, e.g., the protein BSA, is allowed to physically adsorb to surfaces not covered by capture biomolecules.

The term “active blocking” means a process of linking macromolecules, e.g., proteins or protein resistant polymers, on surfaces to prevent non-specific binding of other compositions such as proteins. The macromolecules are linked to the compositions by any means, e.g., covalently and ionically.

The term “organic thin film” means a thin layer of organic molecules applied to the surface of a substrate.

The term “monolayer” means an organic thin-film that is about a single-molecule thick.

The term “self-assembled monolayer” (SAM) is a monolayer, which is created by the spontaneous assembly of molecules on a surface. The self-assembled monolayer may be formed by a single component or by more than one type of molecule, resulting in a mixed self-assembled monolayer.

The term “analyte” is a compound to be detected or measured in a test sample with at least on binding site to a capture molecule.

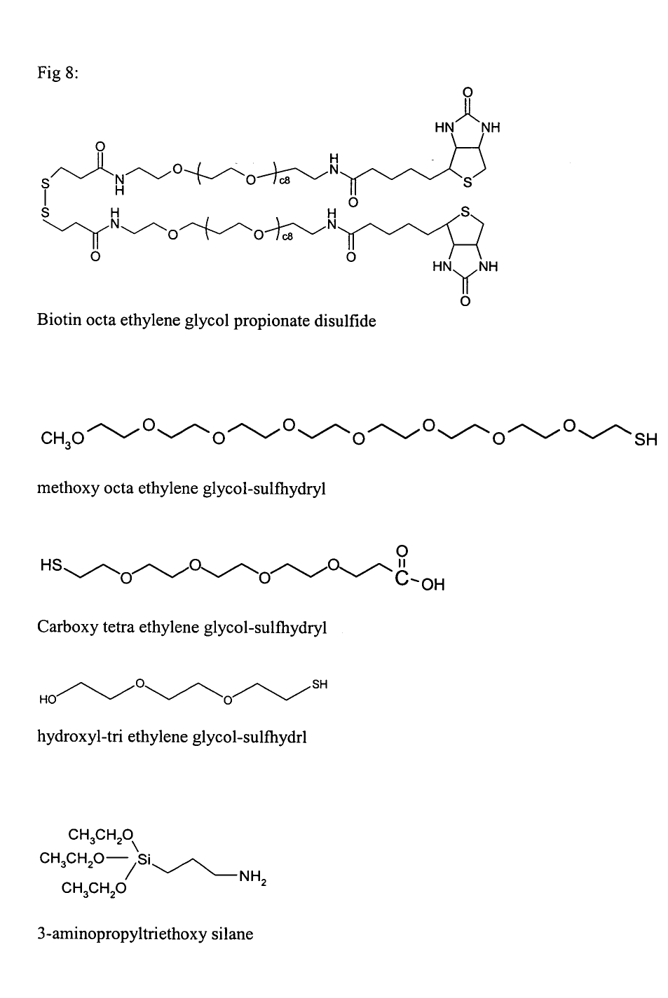

FIG. 8 shows the structure and names of compounds used in the present invention.

In one aspect, the present invention provides a method of functionalizing cantilever surfaces, including immobilizing biomolecules on one surface and actively blocking the non-functionalized surface of bimetallic cantilevers. These surface chemistry procedures relate to sensing macromolecules such as proteins by using cantilever-based biosensors.

A stable and reproducible method of immobilizing molecules is important for increasing the performance of biosensors. The immobilized biomolecular layer affects biosensor selectivity, reproducibility and resolution.

Attachment chemistries applied to cantilever surfaces are known, see, e.g., Hermanson, Bioconjugate Techniques. Academic Press, San Diego, Calif. (1996). Proteins can non-covalently, physically adsorb onto surfaces such as gold, silicon or polystyrene. Because this method of attachment denatures proteins and results in random orientation, it is not preferable for use in a robust biosensor. Butler, et al., Mol. Immunol. 30:1165-1175 (1993). Covalent immobilization of capture molecules is strong, reproducible and results in an orientation that facilitates interaction with ligands. Pathways for in situ surface activation chemistry that result in multiple functionalities such as carboxyl, hydroxyl, amino and N-hydroxysuccinimide (NHS) have been used for cantilevers, e.g., alkylsiloxane monolayers on hydroxylated silicon surfaces and alkylthiol monolayers on gold metal. (Wu, et al., Nat. Biotechnol. 19:856-860, 2001; Arntz, et al., Nanotechnology 14:86-90, 2003)

These methods produce high density of reactive functionalities on the surface. Depending on the deposited reactive group, further activation steps are necessary for immobilization.

In one aspect, the present invention relates to applying monolayers to both sides of microcantilevers. Microcantilevers are fabricated by standard photolithographic and etching techniques with silicon as the base material. A silicon nitride or silicon dioxide film is deposited on the silicon wafer by a low-pressure chemical vapor deposition process. A gold metal layer coated on one side provides reflectivity and/or attachment of molecules.

Embodiments of the present invention provide methods of modifying any microsurface, e.g., microcantilever surfaces and microchip surfaces. Methods provided herein for modifying cantilever surfaces are useful in modifying other microsurfaces. For example, the present methods may be used to modify a microchip.

Alkylthiols can form monolayers on gold surfaces. As shown in Example 2, a thiol monolayer preferentially forms on the gold layer relative to the silicon layer. The sulfur on the thiol group covalently bonds to the gold substrate (binding energy 120 kJ/mol) and the resulting self-assembled monolayer (SAM) is a closely packed and ordered structure, about one molecule thick. The SAM serves as an interface layer between gold and a ligand present in the test solution. Proteins can be covalently immobilized to the activated SAM through its functional groups. For example, carbodiimides may be used to mediate the formation of covalent bond between an amine present on a protein and a carboxyl functional group terminated SAM.

Similarly, the silicon surfaces can be activated through well-established silanization procedures. Silanes are a group of molecules with a silicon atom bound to four variable groups. Examples of silanes include aminosilanes such as aminopropyltriethoxylsilane, N-(2-Aminoethyl)-3-Aminopropyl trimethoxysilane, 3-Aminopropyl-trimethoxysilane, chlorosilanes and mecaptosilanes. The oxygen of hydroxyl groups at the silicon surface may substitute one or several of the four groups in the silane. Proteins can be covalently bound to an aminosilanized surface by the use of a linker molecule, such as glutaraldehyde.

In one aspect, the invention provides simultaneous chemical modification of the top and bottom surfaces of cantilevers. The thiol molecules required for gold surface modification and the silane molecules required for silicon surface modification are both soluble in high purity solvents. Examples of high purity solvents include methanol, ethanol and toluene. The two surface modifying chemicals, the thiol compound and the silane compound, are mixed together in a suitable solvent and allowed to chemically adsorb on cleaned cantilevers. Due to the affinity of thiol molecules for gold, the thiol molecules react and form an S-Au linkage. As shown in Example 3, thiol SAMs form on gold surfaces in the presence of silane compounds.

Similarly, the silane in the mixture reacts with hydroxyl groups present on the silicon surface to form covalent linkage. There is minimal competition between thiols and silanes to form thin films on their respective surfaces. Since no active species are formed during this process, there is no cross reactivity between active groups. Further, solvents are used to wash away any molecules that are merely physically adsorbed on the surfaces. The thiol compound or the silane compound can be selected to contain a functional group to be exploited for immobilization of biomolecules. The other surface can be coated covalently with a protein resistant molecule such as oligoethylene glycol or polyethylene glycol. The chemical modification of the top and bottom surfaces can also be performed sequentially.

In one embodiment, carboxyl terminated oligoethylene glycol thiol molecules (e.g., (23-(9-Mercaptononyl)-3,6,9,12,15,18,21-Hepatoxatricosanic acid, mercapto octa ethylene glycol acid, etc.) are mixed with trialkoxy silanes (e.g. aminopropyltriethoxylsilane APTES, N-(2-Aminoethyl)-3-aminopropyl trimethoxysilane, 3-Aminopropyl-trimethoxysilane) in methanol or ethanol, or in another suitable solvent, and allowed to form thin film base layers on cantilevers. A carboxyl-terminated thiol based SAM forms on gold surfaces and amine terminated silane layers form on silicon surfaces.

After forming the SAMs, the amines on silicon are blocked, for example, with small chain length hydrophilic protein resistant oligoethylene glycol molecules (e.g. N-Hydroxysucciniimide (NHS) ester of methoxy or hydroxy terminated oligoethylene glycol). The NHS group reacts with amine groups to form a stable covalent amide linkage. Although ethylene glycol-based compounds are used in examples herein, any compound that binds to amine-terminated silicon surface and inhibits non-selective protein binding can be used and is within the scope of methods herein.

Capture biomolecules are attached to carboxyl-terminated gold surface with a water soluble cross linker reagent such as carbodiimides (1-ethyl-3-(3-dimethylaminopropyl) carbodiimide, EDC or EDAC). The cross-linker mediates formation of an amide linkage between free amine and carboxyl groups.

In another embodiment of the invention, active blocking of silicon surfaces is performed using silanated hydroxy or methoxy terminated oligoethylene glycol. Such compounds may be synthesized by coupling silanes to oligoethylene glycols through urethane bonds.

In another embodiment of the invention, the thiol-based SAM formed on the gold surface is a mixed monolayer comprising more than one thiol compound. For example, a mixed SAM was formed using 1-(9-mercaptononyl) 3,6,9-trioxaundecan-11-ol and 23-(9-mercaptononyl)-3,6,9,12,15,18,21-heptaoxatricosanoic acid at a ratio of 1:10, or about 1:5, or about 1:2, or about 1:1, or any other optimal ratio as determined by one of ordinary skill in the art of chemistry. Such a film reduces steric hindrance, improves specific binding and further reduces non-specific binding.

In an alternative embodiment, the thiol component is replaced with a plurality of different thiols (“mixed SAMs”), with one or more thiols providing functionality and one or more thiols mediating protein repulsive properties on the gold surface. Mixed SAMs provide an opportunity to finally regulate the amount of functional groups on the surface. A preferred mixed SAM formed in the present invention includes for example, two thiols like sulfhydryl-tetra ethylene glycol acid and sulfhydryl-tri ethylene glycol. In one embodiment, a 1:10 molar ratio (for example, a final concentration of 0.1:1 mM) is used to form the mixed SAM, which reduces the number carboxyl groups on the surface. In turn, this reduction in carboxyl groups reduces electrostatic interactions between carboxyl-terminated surface and other negatively charged groups of molecules present in the test sample, improving the performance of the biosensor.

In still another embodiment, terminal biotin functional groups may be present in the SAM formed on gold. Such a SAM acts as a universal base layer, to which different capture molecules are immobilized. This immobilization is accomplished several ways. In one embodiment, avidin-conjugated capture molecules are added to the biotin-SAM. Alternatively, the biotin layer is first exposed to avidin, which has available biotin binding sites. In this approach, immobilizing is adding a biotin-labeled capture molecule. An additional advantage of this strategy is the ability to orient capture molecules on the surface. For example, antibodies can be specifically biotinylated at the Fc portion, keeping the Fab domain free to interact with antigens.

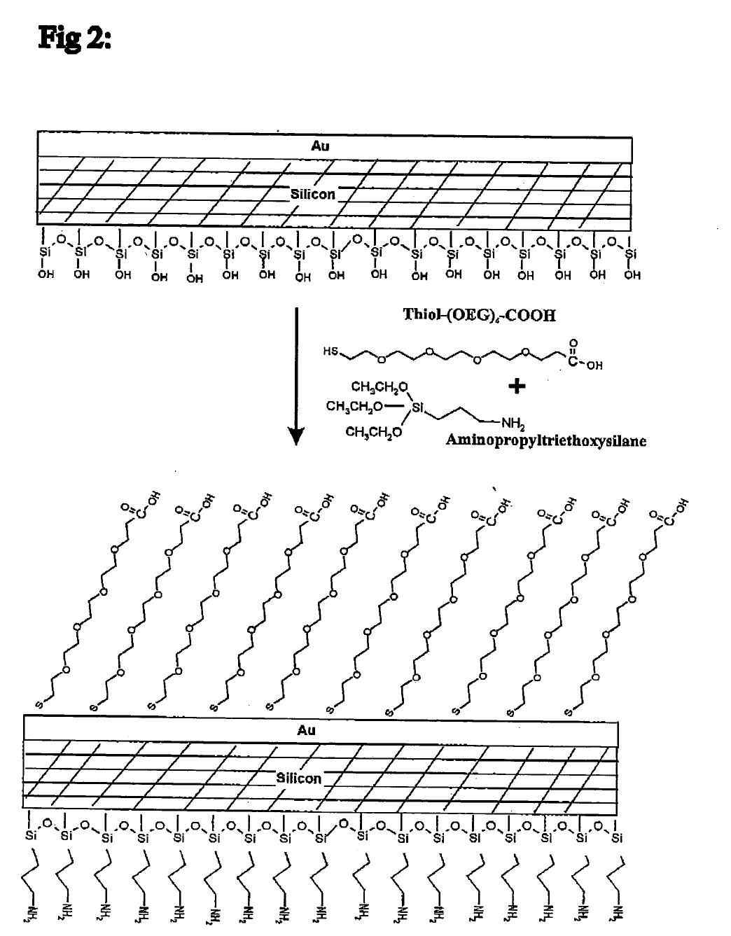

FIG. 2 shows steps for immobilizing biomolecules on gold surfaces and actively blocking silicon cantilever surfaces. The substrates are ozone cleaned on both sides for 20 minutes. This is followed by immersion in 0.5 M NaOH for 20 minutes, 0.1 M HCl for 10 minutes. This washing cycle is repeated and the substrates are washed in water.

As shown in FIG. 2a, the cleaned substrates are exposed to a solution containing 1 mM sulfhydryl tetra ethylene glycol acid and 2% APTES in acidified methanol/water (95%/5%) for two hours at room temperature under nitrogen. The OEG thiol assembles onto the bare gold surface to produce a monolayer that terminates in a carboxyl functional group and is hydrophilic monolayer. The APTES preferentially forms amine-terminated layers on the silicon surface. This procedure produces a gold surface reactive for attachment of biomolecules.

As shown in FIG. 2b, the amine-terminated silicon surface is again exposed to solution containing NHS ester of methoxy triethylene glycol. The NHS ester reacts with the free amine groups to from stable amide linkage.

This method provides a way of treating a cantilever surface for use in biosensors. In another embodiment, a silanated OEG compound is used; such compounds are synthesized by direct coupling of OEG with silanes through a urethane bond.

In one embodiment, capture biomolecules are immobilized to the gold surface by using a zero length cross-linker such as carbodiimide. Water-soluble carbodiimides are used to mediate the formation of amide linkages between a phosphate and an amine present in the capture biomolecule. The stability of the active intermediate formed by (1-ethyl-3-(3-dimethylaminopropyl carbodiimide) (EDC) may be increased by adding N-Hydroxysulfosuccinimide (sulfo-NHS). Excess reagent and the isourea byproduct formed during reaction are water-soluble and washed away. The terminal carboxyl groups are reacted with 200 mM EDC and 50 mM sulfo-NHS for 20 minutes in MES buffer (0.1 mM 2-N-morpholino)ethanesulfonic acid, 0.9% NaCl, pH 4.7). After washing, the surface is exposed to 100-200 μg/ml of capture molecule for one hour. Un-reacted capture molecules are further washed away.

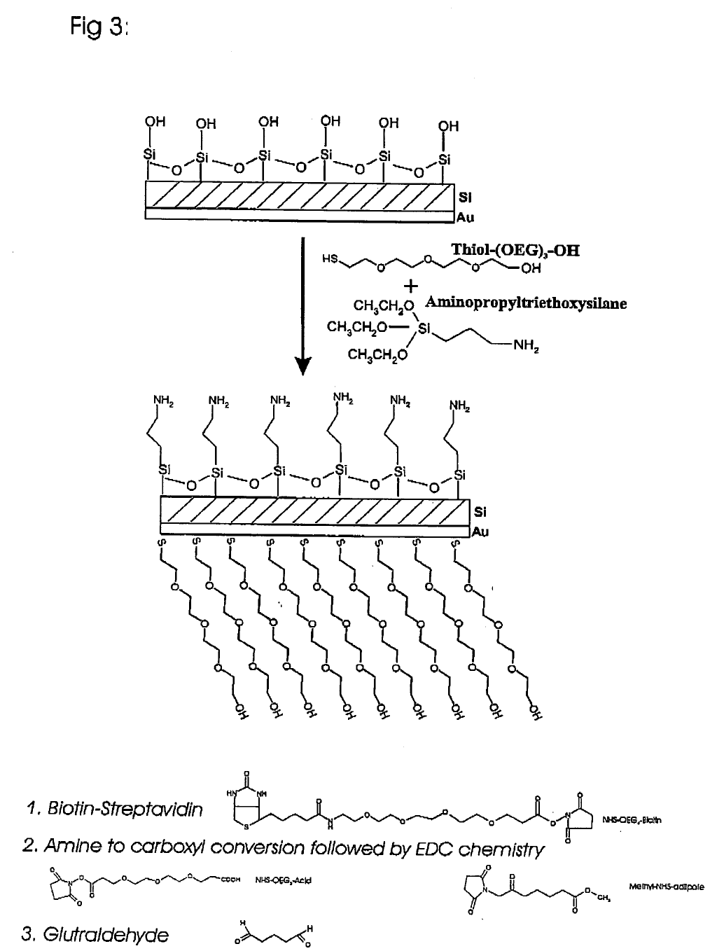

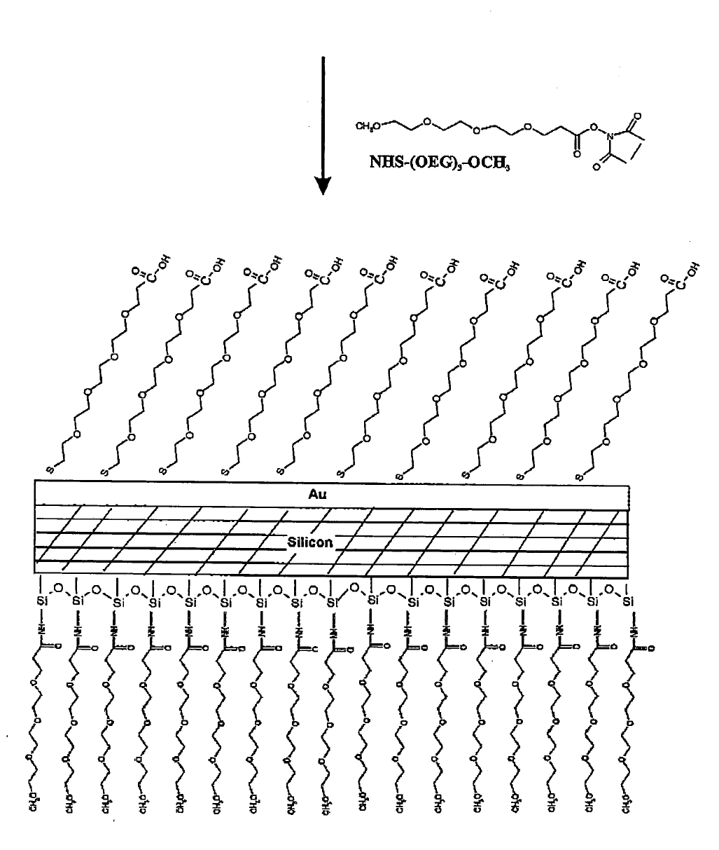

In another aspect of the present invention, capture biomolecules are immobilized on the silicon surface of the cantilever. Referring to FIG. 3, one or more trialkoxy silanes, e.g. aminopropyl triethoxysilane (APTES) are mixed with hydroxy- or methoxy-terminated oligoethylene glycol thiols (e.g. triethylene glycol thiol) in ethanol or methanol, or another suitable solvent, and allowed to chemically adsorb to form organic thin films on cantilever surfaces. Then, the amine terminated silicon surface are linked to proteins by using a homobifunctional cross-linker such as glutaraldehyde.

In an alternative embodiment, the amine-terminated silicon surfaces are converted into carboxyl functional group by using an amine reactive modification reagent such as Methyl-N-succimimidyl adipate. The methyl ester-protecting group is released, exposing the carboxylate for further conjugation by applying carbodiimide chemistry.

In still another embodiment, mixed silane layers on the silicon surface are formed by co-adsorption of functional silanes (APTES) and non-functional silanes (hydroxyl terminated silanes) and subsequent modification of amino groups to immobilize capture molecules.

In another embodiment, the cleaned substrates are exposed to a solution containing 1 mM sulfhydryl tri ethylene glycol and 2% APTES in acidified methanol/water (95%/5%) for two hours at room temperature under nitrogen. The APTES forms amine-terminated layers preferably on the silicon surface. This procedure produces a base SAM on the gold surface to reduce non-specific adsorption. The silanol group is a poor leaving group hence common cross-linking reagents cannot be used to attach biomolecules directly to the silicon surface. Organosilanes such as APTES are used for attachment purpose. The silanes cross-link covalently through a condensation reaction, ethoxy groups hydrolyze and the organosilanes form hydrogen bonds with surface silanol groups. The liquid phase silanization procedure used herein may result in more than one molecule layer on the silicon side.

The amine functional groups on the silicon surfaces are used for the immobilization of capture molecules. In another embodiment, a homo bifunctional reagent glutaraldehyde (2% v/v) is reacted to amine groups for two hours. After washing excess reagent, 200 μg/ml of capture molecules are added for another two hours. Sodium borohydride (10 mg/ml) may be added and incubated for one hour in order to reduce Schiff bases and any excess aldehydes.

In another embodiment, the amine group may be converted into carboxyl functional group by using a modification reagent. The amine-terminated surfaces are reacted with 1 mg/ml of Methyl N-succimimidyl adipate (MSA) in 0.1 M sodium phosphate, 0.15 M NaCl, pH 7.2 for 30 minutes. The methyl ester-protecting group is subsequently removed by incubation at pH 9.5 in phosphate buffer exposing the carboxyl groups. Capture molecules are immobilized by carbodiimide condensation reaction as previously described.

In still another embodiment, NHS ester of biotin is reacted with the silicon surface terminated amine groups to create a biotin surface. Capture biomolecules are immobilized by several methods as described herein.

The surface chemistry methods herein are useful for any number of biosensing applications, using cantilever platform technology biosensors. For example, protein detection, protein-protein interactions, binding affinities, enzyme activity and ligand fishing can be exhaustively analyzed. Similarly, immobilizing nucleic acids facilitates molecular biological research studies such as DNA or RNA detection and single nucleotide mismatch identification.

The methods and devices relating to immobilizing proteins on one side and reducing the adsorption of proteins on the other side of cantilevers, are also suitable for immobilizing and reducing non-specific binding of nucleic acids or other macromolecules. Surfaces can be used in place of the gold surface including, but not limited to, aluminum, copper, gold, chromium, titanium and silver. Similarly, in another embodiment, surfaces can be used in place of the silicon surface including, but not limited to aluminum oxide, iridium oxide, silicon, silicon oxide, silicon nitride, tantalum pentoxide, and a plastic polymer.

The oligo ethylene glycol compounds used herein contribute to tailoring cantilever surfaces for use in biosensors. In various embodiments, a wide range of functional groups are incorporated in the molecular structure of OEG based compounds. For example, in one embodiment, thiols are synthesized on one end to covalently bind to the gold, while carboxyl, amine or biotin functional groups are present on the other end for attaching biomolecules.

In the oligo ethylene glycol compounds, the ethylene glycol repeating units resist non-specific binding of other biomolecules on to the surface by repulsive electrostatic force, and by keeping a water interface between a surface and distal end of the molecule. The strategy of using ethylene glycol based compounds for modifying cantilever surfaces thereby reduces non-specific absorption compared to use of adhesive proteins such as BSA. Additionally, the self-assembled monolayer formed on the gold by the methods herein is stable in air and water.

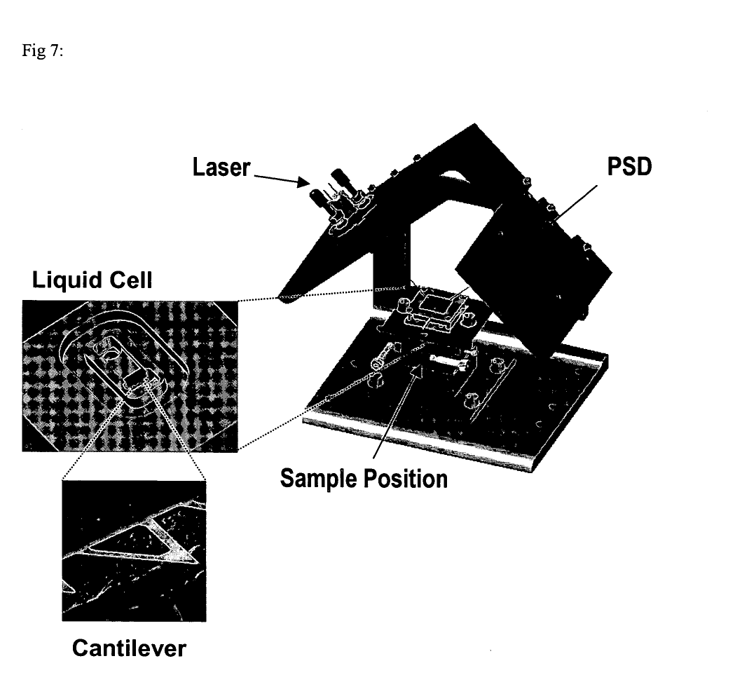

The modified cantilevers herein may be used in a detection system for monitoring interaction of immobilized biomolecules. Referring to FIG. 7, in one embodiment, a cantilever deflection detection unit is used to monitor interaction of immobilized biomolecules with an analyte. While there are multiple methods of detection, this example uses the optical beam bounce method. In the illustrated detection unit, a laser spot is focused at the tip of the cantilever. A position sensitive device monitors the reflected beam. When the cantilever bends as a result of biospecific binding and associated surface stress, the reflected laser spot moves on the photo detector surface to result in a voltage change. The change in cantilever deflection is a function of the amount of analyte binding to capture biomolecules. The optical beam bounce method is very sensitive and can measure up to 0.1 nm deflection of the cantilever. The optical assembly includes the laser diode, including systems for its alignment, focusing and control, and the position-sensitive detector (PSD).

Since cantilevers are sensitive to external influences such as temperature and turbulence, a reference cantilever is used along with the test cantilever. It is beneficial to use an array comprising a plurality of cantilevers, where one of the cantilevers functions as a reference cantilever. Hence, another embodiment of the device monitors deflections of multiple cantilevers in an array. The system consists of a laser array, a system for alignment and a PSD array.

All publications and patent documents cited herein are incorporated herein by reference Citation of publications and patent documents is not intended as an admission that any is pertinent prior art, nor does it constitute any admission as to the contents or date of the same. The invention having now been described by way of written description, those of skill in the art will recognize that the invention can be practiced in a variety of embodiments and that the foregoing description and examples below are for purposes of illustration and not limitation of the claims that follow.

### EXAMPLES

### Example 1

### Non-Specific Protein Interactions on Untreated Gold and Silicon Surfaces

Non-specific protein interactions with gold and silicon surfaces were analyzed by immunofluroescence. In this example, the substrates were 1.6×3.6 mm sized silicon chips coated on one side with a 30 nm layer of gold. While chips were selected as the substrate for ease of use and throughput, the results obtained herein also apply to other substrates such as cantilever surfaces. These chips have the same surface characteristics as cantilever surfaces used in nanomechanical biosensors. In fact, these chips are the base material from which cantilevers are etched.

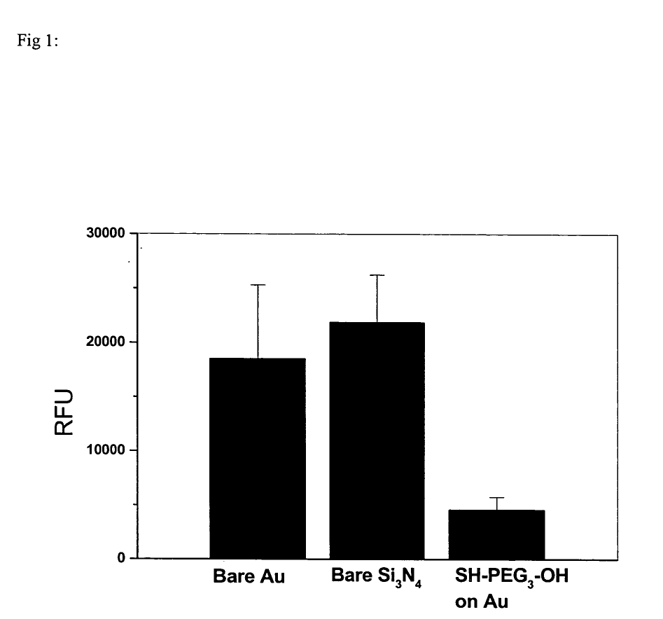

In this example, the chips were ozone cleaned for 20 minutes and incubated for one hour with 100 μg/ml of normal mouse IgG protein solution in phosphate buffered solution (PBS). The chips were then washed and exposed for one hour to a solution containing anti-mouse IgG-Texas Red (TR). After the one-hour exposure, the surfaces were washed and the fluorescence on the gold surface was measured using a fluorimeter. Referring to FIG. 1, both gold (Bare Au) and silicon nitride (Bare Si₃N₄) surfaces showed very high fluorescence as a result of mouse IgG binding. In contrast, the gold surface coated with a protein resistant molecule (SH-PEG₃-OH on Au) showed statistically significant less fluorescence as a result of decreased mouse IgG binding. These results show the extent of non-specific interactions with untreated surfaces.

### Example 2

### Preferential Formation of Thiol SAMs on Gold Surfaces

The ability to form thiol SAMs on gold surfaces while not forming thiol SAMs on silicon surfaces was analyzed by immunofluorescence. In this example, silicon chips (1.3×3.6 mm) are used with gold coated on one side (30 nm). A solution of biotinylated octa ethylene glycol disulfide compound (1 mM) and 2% silane in methanol was contacted to cleaned substrates as per the method illustrated in FIG. 2. After washing, the chips were probed with Streptavidin-Texas Red conjugate and the fluorescence on the surface was measured using a fluorimeter. The fluorescence measurement correlates with the amount of streptavidin binding to the biotin.

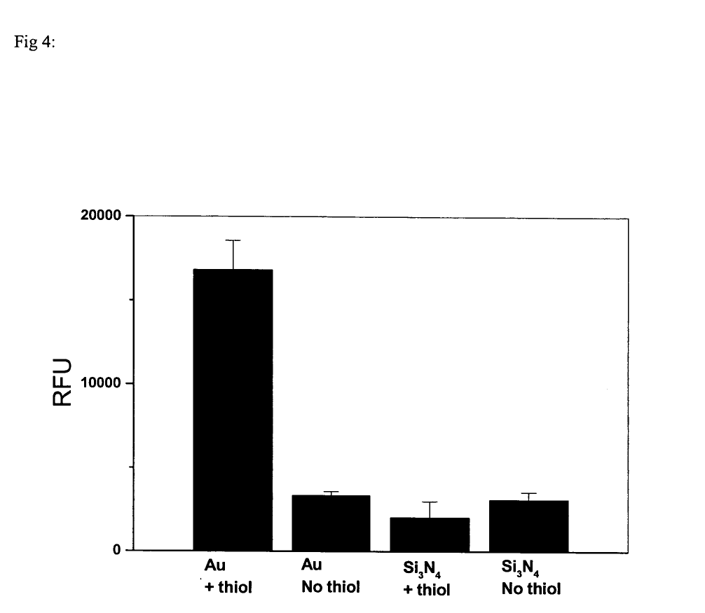

Referring to FIG. 4, a statistically significant difference in fluorescence between the gold surface treated with the thiol compound (Au+ thiol) and the untreated gold surface (Au No Thiol) was found. This difference reflects the formation of a biotin-terminated SAM on the treated gold surface, which binds the streptavidin-TR. Conversely, there was no statistically significant difference observed in fluorescence between the silicon surface treated with the thiol compound (“Si₃N₄+thiol”) and the untreated silicon surface (“Si₃N₄ No Thiol”). This lack of a difference was due to no biotin-terminated SAM having been formed on the treated silicon surface.

In comparing the treated gold surface and the treated silicon surface, there was a statistically significant difference observed in fluorescence between the gold surface treated with the thiol compound (“Au+ thiol”) and the silicon surface treated with the thiol compound (“Si₃N₄+thiol”). These bars compare the relative fluorescence units (n-3) between the gold and silicon nitride surfaces. The fluorescence intensity was high on the gold, due to the formation of biotin terminated SAM (“Au+ thiol”), however no such activity was seen on silicon nitride surfaces (“Si₃N₄+thiol”). These data support the concept that thiols form SAMs on gold surfaces and not on silicon surfaces when substrates are exposed to a mixture containing thiol and silanes.

### Example 3

### Formation of Thiol SAMs on Gold Surfaces in the Presence of a Silane Compound

The ability to form thiol SAMs on gold surfaces in the presence of a silane compound was analyzed by immunofluorescence. Silicon chips coated on one side with gold were used. The first group of chips was exposed to 1 mM biotin octa ethylene glycol sulfhydryl in methanol. The second group of chips was treated with a mixture of 1 mM biotin octa ethylene glycol sulfhydryl and 2% silane in methanol. After washing, the chips were probed with Streptavidin-Texas Red conjugate and the fluorescence on the surface was measured using a fluorimeter. The fluorescence measurement correlates with the amount of streptavidin binding to the biotin.

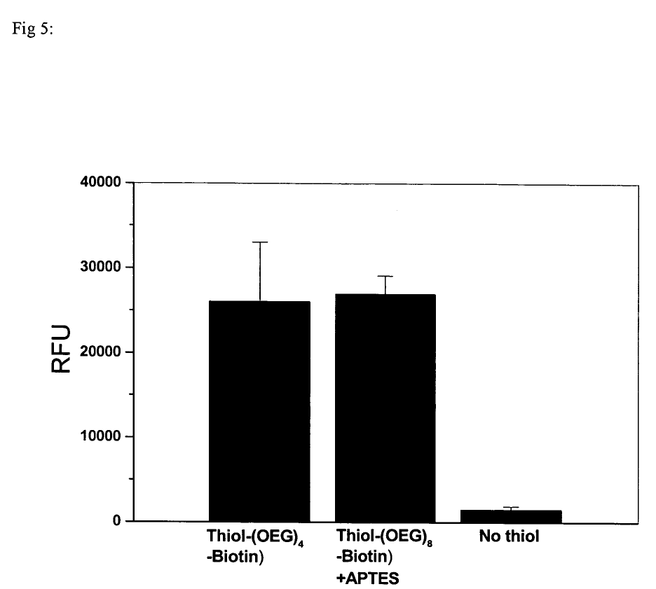

Referring to FIG. 5, a statistically insignificant difference was observed in fluorescence between chips treated in the presence (Thiol-(OEG)₈-Biotin+APTES) compared to the absence (Thiol-(OEG)₄-Biotin) of a silane compound. Further, chips treated in the presence or absence of a silane compound both showed a statistically significant increase in fluorescence in comparison to chips not treated with a thiol compound. The results demonstrate that the presence of silanes in the mixture does not interfere with the formation of a thiol SAM on the gold surface.

### Example 4

### Prevention of Non-Specific Protein Interactions by Active Blocking

The ability to prevent non-specific binding of proteins by actively blocking a silicon surface was analyzed by immunofluorescence. In this example, silicon chips with gold coated on one side were used. A first group of chips was treated with 2% silane. A second group of chips was blocked with NHS ester of methoxy tri ethylene glycol after silanization. A third group of chips was treated with a solution mixture containing 1 mM biotin octa ethylene glycol sulfhydryl and 2% APTES followed by blocking with NHS ester of methoxy tri ethylene glycol. All the chips were then exposed for one hour to 200 μg/ml of mouse IgG. After washing, the chips were probed with anti-mouse IgG-Texas Red conjugate.

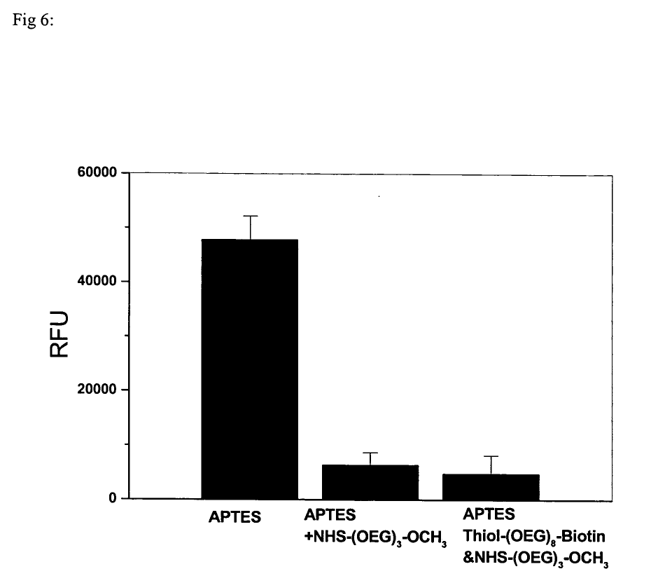

Referring to FIG. 6, the unblocked chips (APTES) were observed to produce a strong fluorescence signal. Conversely, the chips with blocked silicon surfaces showed a statistically significant decrease in fluorescence compared to the unblocked chips. This decrease in fluorescence corresponds to a decrease in non-specific protein interactions with the silicon surface. Consequently, the amine-terminated surfaces strongly adsorbed proteins, whereas the actively blocked silicon surfaces, according to an embodiment of the present invention, prevented non-specific binding of mouse IgG.

1. A method for modifying a substrate having a first surface and a second surface for immobilizing capture biomolecules on the first surface and blocking the second surface with molecules resistant to non-specific interactions, the method comprising
contacting the first surface with at least one thiol compound and the second surface with at least one silane compound;
blocking the second surface with an NHS ester of an oligo ethylene glycol (OEG) compound; and
immobilizing a capture biomolecule with a cross-linking agent to a terminal active group on the first surface, thereby modifying the substrate.

2. The method of claim 1, wherein the first surface is selected from at least one of the group consisting of aluminum, copper, gold, chromium, nickel, platinum, titanium and silver.

3. The method of claim 1, wherein the second surface is selected from the group consisting of aluminum oxide, iridium oxide, silicon, silicon oxide, silicon nitride, tantalum pentoxide, and a plastic polymer.

4. The method of claim 1, wherein the first surface comprises gold and the second surface comprises silicon.

5. The method of claim 1, wherein contacting the first surface and the second surface is simultaneous.

6. The method of claim 5, wherein contacting further comprises applying an organic solvent containing the thiol compound and the silane compound.

7. The method of claim 1, wherein contacting the first surface and the second surface is sequential.

8. The method of claim 1, wherein the thiol on the first surface and the silane on the second surface are monolayers.

9. The method of claim 1, wherein the thiol comprises SH-(oligo ethylene glycol)ₙ-R, wherein n is an integer that is at least 2 and R is an active functional group.

10. The method of claim 9, wherein the active functional group is selected from COOH, NH₂ NHS, epoxy, vinyl, aldehyde, maleimide, and methacryl.

11. The method of claim 1, wherein the thiol compound comprises sulfhydryl octaethylene glycol propionic acid or sulfhydyl tetraethylene glycol acid.

12. The method of claim 1, wherein the thiol compound comprises at least one of sulfhydryl octaethylene glycol propionic acid, sulfhydyl tetraethylene glycol acid and sulfhydryl triethylene glycol.

13. The method of claim 12, wherein a molar ratio of sulfhydryl octaethylene glycol propionic acid to sulfhydryl triethylene glycol is selected from the group of about 1:10, about 1:5, about 1:2, and about 1:1.

14. The method of claim 12, wherein a molar ratio of sulfhydryl tetraethylene glycol acid to sulfhydryl triethylene glycol is about 1:10, about 1:5, about 1:2, and about 1:1.

15. The method of claim 1, wherein the thiol compound comprises biotin-octaethylene glycol disulfide.

16. The method of claim 15, further comprising adding an avidin compound after the contacting step.

17. The method of claim 16, further comprising after adding the avidin compound, adding a biotin-conjugated capture biomolecule.

18. The method of claim 15, wherein immobilizing a capture biomolecule is adding an avidin compound further comprising a capture biomolecule.

19. The method of claim 1, wherein the silane compound is 3-aminopropyltriethoxysilane or an organosilane of formula RₙSi(X)₄₋ₙ, wherein R is a non-hydrolyzable functionalized organic group, X is a hydrolyzable group and n is an integer from one to three.

20. The method of claim 19, wherein the R is at least one selected from the group consisting of an alkyl, an aryl, and an organofunctional group.

21. The method of claim 19, wherein X is an alkoxy.

22. The method of claim 21, wherein the alkoxy is methoxy or ethoxy.

23. A method for modifying microsurfaces for immobilizing capture biomolecules on a first surface of the microsurface and immobilizing molecules resistant to non-specific interactions on
a second surface of the microsurface, the method comprising applying a layer comprising at least one thiol compound to the first surface and a layer comprising at least one silanated hydroxy- or alkoxy-terminated oligoethylene glycol to the second surface; and
blocking the layer on the second surface with an NHS ester of an oligo ethylene glycol (OEG) compound, thereby modifying the microsurfaces.

24. The method of claim 23, wherein the NHS ester of the OEG compound is an NHS ester of tetra ethylene glycol.

25. A method for modifying microcantilever surfaces to immobilize capture biomolecules on a gold surface and to have molecules resistant to non-specific interactions on a silicon surface, the method comprising
applying a layer comprising at least one thiol compound to the gold surface and a layer comprising at least one silane compound to the silicon surface;
blocking the layer on the silicon surface with an NHS ester of an oligo ethylene glycol compound; and
immobilizing a capture biomolecule with a cross-linking agent to a terminal active group formed by the layer on the gold surface, thereby modifying the microcantilever surfaces.

26. The method of claim 25, wherein applying the layer is contacting the microcantilever surfaces with an organic solvent comprising the thiol compound and the silane compound.

27. A method for modifying microsurfaces to immobilize molecules resistant to non-specific interactions on a first side and immobilize capture biomolecules on a second side, the method comprising
applying at least one thiol compound to the first side and at least one silane compound to the second side, wherein the first side is gold and the second side is silicon; and
immobilizing capture biomolecules on the silane-layer of the second side, thereby modifying the microsurfaces.

28. The method of claim 27, wherein applying the thiol compound and the silane compound is simultaneous.

29. The method of claim 27, wherein the thiol compound is sulfhydryl tri ethylene glycol or sulfhydryl octaethylene glycol methyl ether.

30. The method of claim 27, wherein the silane further comprises a terminal group selected from an amine, a chloro and a thiol.

31. The method of claim 27 where the silane is tri alkoxy silane aldehyde.

32. The method of claim 31 where the is tri alkoxy silane is tri methoxy silane or tri ethoxy silane.

33. The method of claim 30, wherein prior to immobilizing the capture biomolecules, the method further comprises converting the terminal amine group to a carboxyl functional group.

34. The method of claim 27, wherein prior to immobilizing the capture biomolecules the method further comprises cross-linking by reacting with glutaraldehyde.

35. The method of claim 33, wherein converting is reacting with methyl-N-succimimidyl adipate, thereby providing the carboxyl functional group.

36. The method of claim 33, further comprising reacting capture biomolecules with the carboxyl functional group.

37. The method of claim 36, wherein reacting comprises cross-linking with carbodiimide.

38. The method of claim 27, further comprising after applying the at least one thiol compound, blocking the thiol layer.

39. The method of claim 38, wherein blocking comprises reacting with a small chain length agent.

40. The method of claim 39, wherein the small chain length agent is triethylene glycol thiol.

41. A method for modifying microcantilevers for immobilizing molecules resistant to non-specific interactions on a gold surface and immobilizing capture biomolecules on a silicon surface, the method comprising
contacting the microcantilever surfaces with an organic solvent containing at least one thiol compound and at least one amine-terminated silane compound, wherein the thiol compound forms a layer on the gold surface and the amine-terminated silane compound forms a layer on the silicon surface; and
immobilizing capture biomolecules on the silane layer by cross-linking, thereby modifying the microcantilevers.

42. A modified substrate, microsurface or microcantilever produced by the method of claim 1.

43. A modified microsurface comprising a silicon wafer with a first surface and a second surface for use in biosensors, wherein the first surface comprises a thiol layer of at least one thiol compound and the second surface comprises a silane layer of at least one silane compound.

44. The modified microsurface of claim 43, wherein the first surface is least one of aluminum, copper, gold, chromium, titanium and silver, and the second surface is selected from the group of aluminum oxide, iridium oxide, silicon, silicon oxide, silicon nitride, tantalum pentoxide, and a plastic polymer.

45. The modified microsurface of claim 43, wherein the thiol layer and the silane layer are monolayers.

46. The modified microsurface of claim 43, wherein the thiol layer further comprises an immobilized capture biomolecule.

47. The modified microsurface of claim 43, wherein the silane layer further comprises a blocking agent.

48. The modified microsurface of claim 43, wherein the thiol layer further comprises immobilized capture biomolecules and the silane layer further comprises molecules resistant to non-specific interactions.

49. The modified microsurface of claim 43, wherein the thiol layer comprises SH-(oligo ethylene glycol)ₙ-R, wherein n is an integer of at least 2 and R is an active functional group.

50. The modified microsurface of claim 43, wherein the active functional group is selected from the group consisting of COOH, NH₂ and NHS.

51. The modified microsurface of claim 43, wherein the thiol layer comprises biotin-octaethylene glycol disulfide.

52. The modified microsurface of claim 51, wherein biotin is conjugated to avidin.

53. The modified microsurface of claim 43, wherein the thiol layer comprises sulfhydryl octaethylene glycol propionic acid.

54. The modified microsurface of claim 43, wherein the thiol layer comprises sulfhydryl octaethylene glycol propionic acid and sulfhydryl triethylene glycol.

55. The modified microsurface of claim 54, wherein a molar ratio of sulfhydryl octaethylene glycol propionic acid to sulfhydryl triethylene glycol is selected from the group of about 1:10, about 1:5, about 1:2, and about 1:1.

56. The modified microsurface of claim 47, wherein the blocking agent comprises an NHS ester of an OEG compound.

57. The modified microsurface of claim 56, wherein the NHS ester of the OEG compound comprises an NHS ester of tetra ethylene glycol.

58. The modified microsurface of claim 43, wherein the silane layer comprises 3-aminopropyltriethoxysilane or an organosilane of RₙSi(X)₄₋ₙ, wherein R is a functionalized organic group, X is a hydrolyzable group and n is an integer from 1 to 3.

59. The modified microsurface of claim 58, wherein the hydrolyzable group is an alkoxy.

60. The modified microsurface of claim 59, wherein the alkoxy is a methoxy or an ethoxy.

61. The modified microsurface of claim 43, wherein the silane layer further comprises an immobilized capture biomolecule.

62. The modified microsurface of claim 43, wherein the silane layer further comprises an immobilized capture biomolecule and the thiol layer further comprises an active blocking agent.

63. The modified microsurface of claim 43, wherein the thiol layer further comprises an active blocking agent.

64. The modified microsurface of claim 63, wherein the blocking agent is a small chain length agent.

65. The modified microsurface of claim 64, wherein the small chain length agent is triethylene glycol thiol.

66. The modified microsurface of claim 43, wherein the thiol layer comprises sulfhydryl triethylene glycol or sulfhydryl octaethylene glycol methyl ether.

67. A microcantilever for use in biosensors comprising a silicon wafer with a gold surface and a silicon surface, wherein the gold surface comprises a thiol monolayer further comprising an active blocking agent; and the silicon surface comprises a silane monolayer further comprising a capture biomolecule.
